(19) United States
(12) Patent Application Publication
(10) Pub. No.: US 2017/0329213 A1
(43) Pub. Date: Nov. 16, 2017

(54) POLARIZATION CONVERSION ELEMENT AND PROJECTOR

(71) Applicant: SEIKO EPSON CORPORATION, Tokyo (JP)

(72) Inventors: Tomohiro TAKAGI, Matsumoto-Shi (JP); Joji NISHIMURA, Matsumoto-Shi (JP); Masashi KATO, Matsumoto-Shi (JP); Shuho KOBAYASHI, Shen zhen (CN); Yuichiro INADA, Matsumoto-Shi (JP); Hiroyuki UMEDA, Matsumoto-Shi (JP)

(73) Assignee: SEIKO EPSON CORPORATION, Tokyo (JP)

(21) Appl. No.: 15/511,392

(22) PCT Filed: Sep. 17, 2015
(86) PCT No.: PCT/JP2015/004743

§ 371 Date: Mar. 15, 2017

(30) Foreign Application Priority Data
Oct. 1, 2014 (JP) 2014-202866

(51) Int. Cl. G03B 21/20; G02B 27/28; G02B 5/30

(52) U.S. Cl. CPC G03B 21/2073; G03B 21/208; G02B 5/3083; G02B 27/283; G03B 21/2066

(57) ABSTRACT

A polarization conversion element which is capable of improving the use efficiency of light, and capable of suppressing deterioration is provided. A polarization conversion element includes a main body provided with a light-transmitting member, a polarized light separation layer that transmits first polarized light of light to be incident, and reflects second polarized light, a reflection layer, disposed between the polarized light separation layer and the light-transmitting member, and a retardation layer, disposed on a light emitting end surface of the light-transmitting member, which converts one polarization direction of the first polarized light and the second polarized light into the other polarization direction; and a reflection suppression layer that suppresses reflection from a light emitting surface in the main body, wherein the main body includes an exposure region for exposing at least a portion of a region of a light emitting-side surface in the retardation layer.

### TECHNICAL FIELD

The present invention relates to a polarization conversion element and a projector.

### BACKGROUND ART

Hitherto, a projector has been known which is provided with a light source device, a light modulation device that modulates light emitted from the light source device to form an image based on image information, and a projection optical device that projects the image onto a projection surface such as a screen. As such a projector, a projector has been known which is provided with a polarization conversion element in order to increase the use efficiency of light used in forming an image (see, for example, PTL 1).

The polarization conversion element included in the projector disclosed in PTL 1 includes a polarized light separation layer and a reflection layer which are alternately disposed in a direction orthogonal to the central axis of a flux of light to be incident, and a retardation layer. Among these layers, the polarized light separation layer reflects S-polarized light out of random fluxes of polarized light incident from a light source, and transmits P-polarized light. The reflection layer reflects S-polarized light incident from the polarized light separation layer, and causes the polarized light to travel in the same direction as the traveling direction of S-polarized light having passed through the polarized light separation layer. The retardation layer is disposed corresponding to the polarized light separation layer, and converts P-polarized light incident from the polarized light separation layer into S-polarized light to emit the converted polarized light. Since light of which the polarization direction is aligned is incident on the light modulation device by such a polarization conversion element, the substantial entirety of light emitted from the light source can be used in the formation of an image performed by the light modulation device.

### CITATION LIST

### Patent Literature

PTL 1: JP-A-2009-258744

### SUMMARY OF INVENTION

### Technical Problem

Incidentally, it is known that, in optical components, a reflection suppression layer is formed by evaporation or the like in order to reduce an interface loss due to a refractive index difference between air and a light-transmitting member such as glass. It is considered that such a reflection suppression layer is formed on a light emitting surface in the polarization conversion element disclosed in PTL 1, and light is effectively emitted to the outside, to thereby improve the use efficiency of light to be incident.

However, in a case where the retardation layer located on the light emitting surface of the polarization conversion element is formed of an organic material, the sealing of the retardation layer with the reflection suppression layer causes a problem of a deterioration in the retardation layer being accelerated. It is considered that this is because free radicals are generated from an organic material (for example, polycarbonate) constituting the retardation layer due to light to be incident and heat generated in association with the incidence of the light, the reflection suppression layer serves as an air shutoff layer in the process of deterioration progress due to further deformation of the free radicals, and the free radicals stagnate on the surface of the retardation layer. That is, in a case where the retardation layer is sealed, there is a problem in that free radicals generated from an organic material due to light and heat are not able to be desorbed to the outside, the stagnated free radicals serve as a promoter, and deterioration generated normally is promoted.

From such problems, a polarization conversion element is needed which is capable of improving the use efficiency of light while suppressing deterioration.

One object of the invention is to provide a polarization conversion element and a projector which are capable of improving the use efficiency of light, and capable of suppressing deterioration.

### Solution to Problem

According to a first aspect of the invention, there is provided a polarization conversion element including: a main body provided with a light-transmitting member, a polarized light separation layer that transmits first polarized light having one polarization direction out of light to be incident, and reflects second polarized light having the other polarization direction, a reflection layer, disposed between the polarized light separation layer and the light-transmitting member, which reflects the second polarized light reflected by the polarized light separation layer, and causes the second polarized light to travel along a traveling direction of the first polarized light having passed through the polarized light separation layer, and a retardation layer, disposed on a light emitting end surface of the light-transmitting member on any light emitting side of the polarized light separation layer and the reflection layer, which converts one polarization direction of the first polarized light and the second polarized light into the other polarization direction and emits polarized light having the converted polarization direction; and a reflection suppression layer that suppresses reflection from a light emitting surface in the main body, wherein the main body includes an exposure region for exposing at least a portion of a region of a light emitting-side surface in the retardation layer.

Here, an example of the retardation layer capable of being exemplified includes an organic retardation layer constituted of an organic material. Further, an example of the organic retardation layer capable of being exemplified includes an organic retardation layer constituted of a high-molecular compound such as polycarbonate.

According to the first aspect, at least a portion of the retardation layer is exposed to the outside by the exposure region. In other words, an area of the retardation layer corresponding to the exposure region is not covered with other layers such as the reflection suppression layer. According to this, the retardation layer is not sealed with the other layers. Therefore, even in a case where free radicals are generated from a material of the retardation layer due to light incident on the polarization conversion element, and heat generated in association with the incidence of the light, the free radicals can be desorbed from the surface of the retardation layer to the outside with the exposure region interposed therebetween. Therefore, it is possible to suppress the progress of a deterioration in the retardation layer due to the free radicals, and to suppress a deterioration in the polarization conversion element.

In addition, since the reflection suppression layer that suppresses reflection is provided on the light emitting surface of the main body, it is possible to prevent light reaching the interface of the main body from returning to the inner side due to internal reflection. Therefore, it is possible to easily emit the light reaching the interface to the outside. Therefore, since the amount of light to be emitted can be made smaller than the amount of incident light, it is possible to improve the use efficiency of light.

In the first aspect, it is preferable that the exposure region is provided in an area having a higher density of light to be emitted than in other areas, on the light emitting-side surface.

Here, it is considered that more free radicals generated due to the light and heat are generated in a portion having a high density of light than in a portion having a low density of the light. For this reason, in a case where the retardation layer located in an area having a high density of light to be incident is sealed with other layers such as the reflection suppression layer, deterioration caused by the free radicals is further promoted.

On the other hand, in the first aspect, the exposure region is provided in an area having a high density of light to be incident from the inner side than in other areas, on the light emitting-side surface. In other words, since a region of the retardation layer which is an area where more free radicals have a tendency to be generated than in other areas is not sealed with other layers such as the reflection suppression layer, the free radicals can be easily desorbed from the surface of the region. Therefore, it is possible to prevent a deterioration in the retardation layer and a deterioration in the polarization conversion element from being promoted.

In addition, on the light emitting-side surface, an area having a relatively low density of light to be incident is not provided with the exposure region, and thus the reflection suppression layer can be formed in the area. Therefore, it is possible to suitably exhibit the effect of an improvement in the use efficiency of the light.

In the first aspect, it is preferable that the area having a higher density of the light than other areas is located in a substantially central portion of the light emitting-side surface, and that the exposure region is provided at the substantially central portion of the light emitting-side surface.

Here, in a case where the polarization conversion element is adopted in a projector including a light source device and a light modulation device that modulates light emitted from the light source device, and the polarization conversion element is disposed on the optical path of light which is emitted from the light source device and is incident on the light modulation device, the density of light incident on the substantially central area of the polarization conversion element is high depending on the type of the light source device, and the density of light to be incident decreases with distance from the substantially central area.

On the other hand, according to the first aspect, on the light emitting-side surface, the substantially central area having a high density of light than other areas is provided with the exposure region. Thereby, a large amount of free radicals generated from the retardation layer due to light to be incident and heat to be generated can be easily desorbed to the outside. Therefore, it is possible to reliably prevent a deterioration in the retardation layer and a deterioration in the polarization conversion element from being promoted.

As described above, the area having a relatively low density of light to be incident is not provided with the exposure region, and thus the reflection suppression layer can be formed in the area. Even in a case where such a reflection suppression layer is formed in the retardation layer, the amount of the free radicals generated due to light to be incident and heat to be generated is smaller than that of the area having a high density of light to be incident, and deterioration is not likely to progress. Therefore, the reflection suppression layer is formed in such an area, and thus it is possible to suitably exhibit the effect of an improvement in the use efficiency of the light.

In the first aspect, it is preferable that the reflection suppression layer is not formed between the light-transmitting member and the retardation layer.

Here, in the reflection suppression layer, an action is used in which reflected light is suppressed due to interference between light reflected from the light incident side of the reflection suppression layer and light reflected from the light emitting side, and changes in the refractive indexes of mediums on the light incident side and the light emitting side in the reflection suppression layer cause an effect of suppressing reflection not to be sufficiently obtained. For this reason, in a case where the reflection suppression layer is formed on the light incident side of the retardation layer, in other words, a case where the retardation layer is located on the light emitting side of the reflection suppression layer, the function of the reflection suppression layer decreases. That is, light has a tendency to be reflected at the interface between the light emitting end surface of the light-transmitting member and the reflection suppression layer, and thus the transmittance of light decreases.

On the other hand, in the first aspect, since the reflection suppression layer is not formed between the light-transmitting member and the retardation layer, light incident on the retardation layer from the main body can be suitably caused to be incident on the retardation layer, and thus it is possible to suitably exhibit the effect of an improvement in the use efficiency of the light.

According to a second aspect of the invention, there is provided a projector including: a light source device; a light modulation device that modulates light emitted from the light source device; a projection optical device that projects the light modulated by the light modulation device; and the polarization conversion element according to the first aspect which is disposed between the light source device and the light modulation device.

According to the second aspect, it is possible to exhibit the same operational effect as that of the polarization conversion element according to the first aspect. In addition, since the use efficiency of light is improved by the polarization conversion element, it is possible to cause higher-luminance light to be incident on the light modulation device, and to thereby increase in the luminance of an image which is formed and projected.

### BRIEF DESCRIPTION OF DRAWINGS

FIG. 1 is a schematic diagram illustrating a schematic configuration of a projector according to a first embodiment of the invention.

FIG. 2 is a plan view schematically illustrating a uniform illumination device in the first embodiment.

FIG. 3 is a schematic diagram illustrating a configuration of a polarization conversion element in the first embodiment.

FIG. 4 is a schematic diagram when the polarization conversion element in the first embodiment is seen from the light emitting side.

FIG. 5 is a schematic diagram when a polarization conversion element of a projector according to a second embodiment of the invention is seen from the light emitting side.

### DESCRIPTION OF EMBODIMENTS

### First Embodiment

Hereinafter, a first embodiment of the invention will be described with reference to the accompanying drawings.

### [Configuration of Projector]

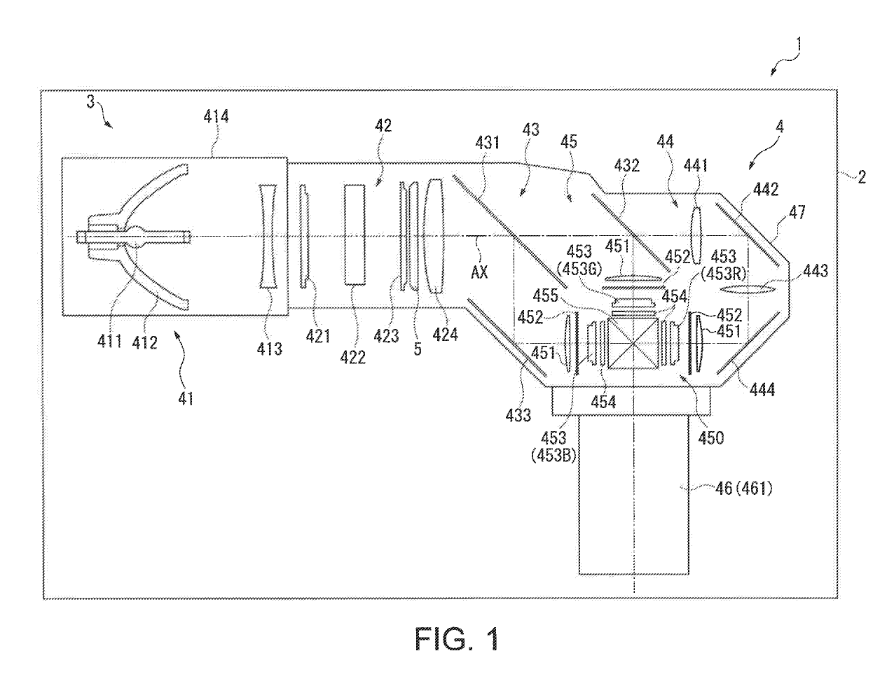

FIG. 1 is a diagram schematically illustrating a schematic configuration of a projector 1 according to the present embodiment.

The projector 1 according to the present embodiment modulates light emitted from a light source device to form an image based on image information, and extendedly projects the image onto a projection surface such as a screen. As shown in FIG. 1, this projector 1 includes an exterior housing 2 constituting an exterior package, and a device main body 3 which is housed within the exterior housing 2.

### [Configuration of Device Main Body]

The device main body 3 is equivalent to an internal configuration of the projector 1, and includes an image forming device 4. Besides, the device main body 3 includes a control device that controls an operation of the entire projector 1, a power supply device that supplies power to electronic parts constituting the projector 1, a cooling device that cools a cooling target constituting the projector 1, and the like which are not shown in the drawing.

### [Configuration of Image Forming Device]

The image forming device 4 forms and projects an image based on image information, under control by the control device. As shown in FIG. 1, this image forming device 4 includes a light source device 41, a uniform illumination device 42, a color separation device 43, a relay device 44, an electro-optic device 45, a projection optical device 46, and a housing 47 for optical components having the respective devices 41 to 44 housed therein.

The light source device 41 emits a flux of light to the uniform illumination device 42. This light source device 41 includes alight source lamp 411, a reflector 412, a collimating lens 413, and a housing 414 having these components housed therein.

The uniform illumination device 42 uniformizes illuminance within a plane orthogonal to the central axis of a flux of light emitted from the light source device 41. This uniform illumination device 42 includes a first lens array 421, a dimming device 422, a second lens array 423, a polarization conversion element 5, and a superposition lens 424, in the order of the incidence of light from the light source device 41. Among these components, the lens arrays 421 and 423 and the polarization conversion element 5 will be described later in detail.

The color separation device 43 separates the flux of light incident from the uniform illumination device 42 into three beams of light of red (R), green (G), and blue (B). This color separation device 43 includes dichroic mirrors 431 and 432 and a reflection mirror 433.

The relay device 44 is provided on the optical path of red light which is larger in optical path than other beams of colored light among three separated beams of colored light. This relay device 44 includes an incident side lens 441, a relay lens 443, and reflection mirrors 442 and 444.

The electro-optic device 45 modulates the respective separated beams of colored light in accordance with image information, and then synthesizes the respective beams of colored light. This electro-optic device 45 includes a field lens 451, an incident-side polarizing plate 452, a liquid crystal panel 453 (liquid crystal panels for red, green, and blue are set to 453R, 453G, and 453B, respectively) as a light modulation device, and an emitting side polarizing plate 454 which are provided for each of the beams of colored light, and a cross dichroic prism 455 as a color synthesis device that synthesizes the respective modulated beams of colored light to form a projection image.

The projection optical device 46 extendedly projects the formed projection image onto the projection surface. This projection optical device 46 is configured as an assembled lens including a plurality of lenses (not shown) and a lens barrel 461 having the plurality of lenses housed therein.

Although not shown in detail, the housing 47 for optical components includes a component housing member that houses various optical components, and a lid-shaped member that blocks an opening for housing components which is formed in the component housing member. An illumination optical axis AX is set inside this housing 47 for optical components, and the respective devices 41 to 46 are disposed at predetermined positions with respect to the illumination optical axis AX. Therefore, when the light source device 41 is disposed in the housing 47 for optical components, the central axis of light emitted from the light source device 41 is coincident with the illumination optical axis AX.

### [Configuration of Lens Array]

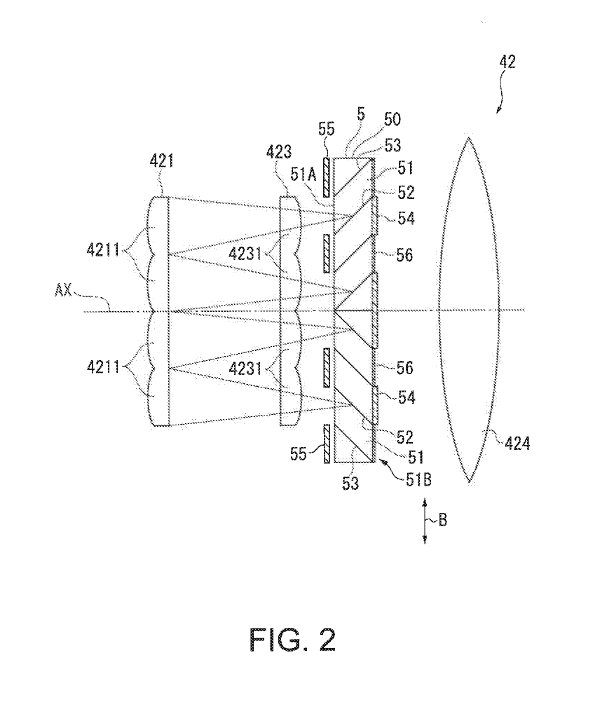

FIG. 2 is a plan view schematically illustrating a configuration of the uniform illumination device 42. That is, FIG. 2 is a schematic diagram when the uniform illumination device 42 is seen from the top surface side in the exterior housing 2. In FIG. 2, the dimming device 422 is not shown.

As shown in FIG. 2, the first lens array 421 has a configuration in which first lenses 4211 which are constituted by a plurality of small lenses are arrayed in a matrix in a plane substantially orthogonal to the illumination optical axis AX. These first lenses 4211 have a contour which is substantially rectangular when seen from the direction of the illumination optical axis A. Each of the first lenses 4211 divides a flux of light emitted from the light source device 41 into a plurality of partial fluxes of light.

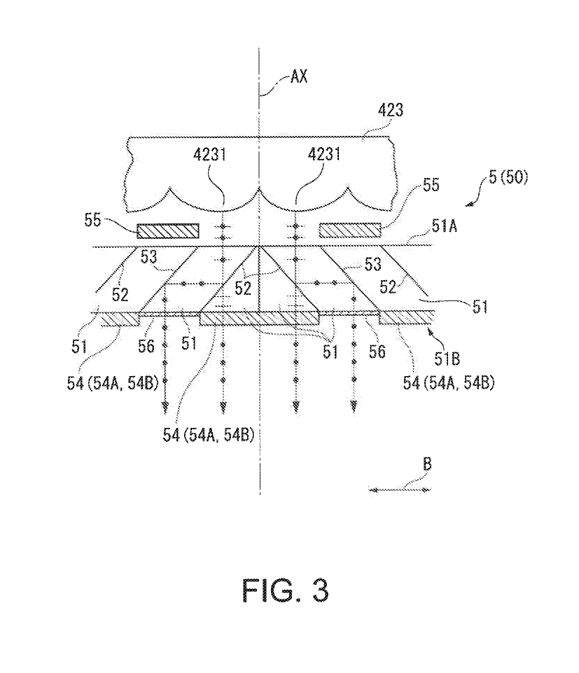

The second lens array 423 has substantially the same configuration as that of the first lens array 421, and has a configuration in which second lenses 4231 (see FIGS. 2 and 3), constituted by small lenses, corresponding to the first lenses 4211 are arrayed in a matrix. This second lens array 423 has a function of forming an image of each of the first lenses 4211 of the first lens array 421 in an image forming region of the liquid crystal panel 453, together with the superposition lens 424.

### [Configuration of Polarization Conversion Element]

The polarization conversion element 5 is disposed between the second lens array 423 and the superposition lens 424, as described above, and is an element that aligns the polarization direction of light to be incident from the second lens array 423 and emits the light.

Specifically, as shown in FIG. 2, this polarization conversion element 5 includes a main body 50 provided with a light-transmitting member 51, a plurality of polarized light separation layers 52, a plurality of reflection layers 53 and a plurality of retardation layers 54, a light shielding plate 55 which is disposed on the light incident side of the main body 50, and a reflection suppression layer 56 which is formed on a light emitting surface 51B of the main body 50.

The main body 50 is a glass substrate in which the polarized light separation layers 52 and the reflection layers 53 are formed inside the light-transmitting member 51, and the retardation layer 54 is formed on the light emitting-side end surface.

In such a main body 50, the polarized light separation layers 52 and the reflection layers 53 are formed in a strip shape having a longitudinal direction in a first direction orthogonal to the illumination optical axis AX, and are alternately formed in the main body 50 along a second direction (direction B in FIGS. 2 and 3) orthogonal to the illumination optical axis AX and the first direction in a state of being inclined approximately 45° with respect to the illumination optical axis AX.

Each of the polarized light separation layers 52 is a layer that transmits polarized light (first polarized light) having one polarization direction out of beams of light to be incident, and reflects polarized light (second polarized light) having the other polarization direction, to thereby separate these beams of linearly polarized light, and is constituted by a dielectric multilayer film. A partial flux of light is incident on each of these polarized light separation layers 52, the flux of light being divided by the first lens 4211 corresponding thereto, and passing through the second lens 4231. In the present embodiment, the polarized light separation layer 52 has the characteristics of transmitting P-polarized light and reflecting S-polarized light.

The reflection layer 53 is a layer that reflects polarized light which is reflected and incident from the polarized light separation layer 52, and causes the polarized light to travel along the traveling direction of polarized light having passed through the polarized light separation layer 52, and is constituted by a dielectric multilayer film, or a reflective film formed of a single metal material, an alloy or the like.

Each of the retardation layers 54 is a layer that rotates the polarization direction of light to be incident and emits the light, and is constituted of an organic material (specifically, high-molecular material such as polycarbonate). In the present embodiment, these retardation layers 54 are disposed at positions corresponding to the polarized light separation layer 52 on the light emitting-side end surface of the main body 50. In such a retardation layer 54, linearly polarized light (P-polarized light in the present embodiment) passing through the polarized light separation layer 52 and being incident has the polarization direction thereof rotated by 90° and is converted into another linearly polarized light (S-polarized light in the present embodiment), and the another linearly polarized light is emitted.

The light emitting surface 51B in the main body 50 is a light emitting-side surface of the main body 50 including a light emitting-side surface 54A of the retardation layer 54. That is, the light emitting surface 51B is a surface where a region having the retardation layer 54 not formed therein and the light emitting-side surface 54A are united with each other, on the light emitting-side surface (light emitting end surface) of the light-transmitting member 51 constituting the main body 50.

Such a retardation layer 54 is provided with a region in which a sealing layer such as the reflection suppression layer 56 described later is not formed, that is, an exposure region 54B in which at least a portion of the light emitting-side surface 54A is exposed to the outside.

Each light shielding plate 55 is disposed on the light incident side of the main body 50. The light shielding plate 55 is formed of stainless steel, an aluminum alloy or the like, and is provided at a position corresponding to the reflection layer 53 on a light incident surface 51A of the main body 50. Light is prevented from being directly incident on the reflection layer 53 by such a light shielding plate 55.

The reflection suppression layer 56 has a function of reducing an interface loss due to a refractive index difference between air and the light-transmitting member 51 of the main body 50, that is, a function of suppressing the generation of internal reflection at the interface between the light-transmitting member 51 and air due to a thin layer having a refractive index different from that of the light-transmitting member 51, and increasing the amount (luminance) of polarized light emitted from the polarization conversion element 5. This reflection suppression layer 56 is formed by being evaporated on the light emitting surface 51B. Specifically, in the present embodiment, the reflection suppression layer is formed in a region excluding the retardation layer 54, on the light emitting surface 51B. An example of such a reflection suppression layer 56 capable of being exemplified includes an AR coating (anti-reflective coating) which is formed by evaporating substances such as silicon dioxide and titanium oxide.

FIG. 3 is a partially enlarged cross-sectional view of the polarization conversion element 5.

Reference will be made to FIG. 3 to describe a case where the polarized light separation layer 52 of the polarization conversion element 5 described above transmits the P-polarized light and reflects the S-polarized light.

The partial flux of light emitted from the second lens 4231 of the second lens array 423 passes between the light shielding plates 55, is incident on the light incident surface 51A of the polarization conversion element 5, and then is incident on the polarized light separation layer 52 through the light-transmitting member 51 of the main body 50. This polarized light separation layer 52 transmits P-polarized light included in the partial flux of light, and reflects S-polarized light toward the reflection layer 53 by converting an optical path by 90°.

The S-polarized light incident on the reflection layer 53 has the optical path thereof converted by 90° toward the light flux emitting side by being reflected from the reflection layer 53, progresses in substantially the same direction as the illumination optical axis AX, and is emitted through the reflection suppression layer 56.

On the other hand, the P-polarized light having passed through the polarized light separation layer 52 is incident on the retardation layer 54, has the polarization direction thereof rotated by 90° due to the retardation layer 54, and thus is emitted as the S-polarized light. Thereby, substantially one type of S-polarized light is emitted from the light emitting surface 51B of the polarization conversion element 5.

[Position at which Reflection Suppression Layer is Formed]

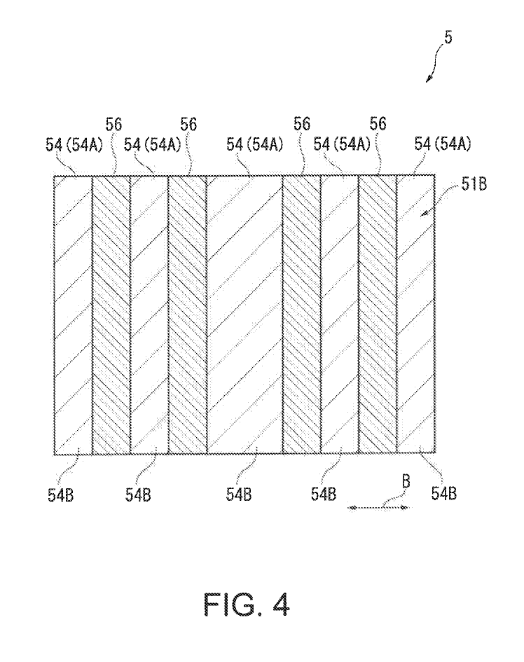

FIG. 4 is a schematic diagram when the polarization conversion element 5 is seen from the light emitting side.

As shown in FIG. 4, the light emitting surface 51B of the main body 50 is formed in a state where the retardation layer 54 and the reflection suppression layer 56 are alternately disposed in a strip shape in a horizontal direction (direction B).

In addition, the reflection suppression layer 56 is provided in a region excluding the retardation layer 54 on the light emitting surface 51B, that is, at a position corresponding to the reflection layer 53 of the main body 50. In addition, since the reflection suppression layer 56 is not provided in the retardation layer 54 on the light emitting surface 51B, the retardation layer 54 constituted of an organic high-molecular material is not sealed with the reflection suppression layer 56. In other words, the entire region of the retardation layer 54 is configured as the exposure region 54B. Thereby, even in a case where free radicals are generated from a material of the retardation layer 54 due to light incident on the polarization conversion element 5, and heat generated in association with the incidence of the light, the free radicals can be desorbed from the light emitting-side surface 54A of the retardation layer 54 to the outside with the exposure region 54B interposed therebetween, and thus it is possible to reduce the possibility of the free radicals stagnating in the retardation layer 54.

### Effects of First Embodiment

According to the projector 1 of the present embodiment described above, the following effects are exhibited.

According to the polarization conversion element 5 of the present embodiment, at least a portion of the retardation layer 54 is exposed to the outside by the exposure region 54B. In other words, an area of the retardation layer 54 corresponding to the exposure region 54B is not covered with other layers such as the reflection suppression layer 56. According to this, the retardation layer 54 is not sealed with the other layers. Therefore, even in a case where free radicals are generated from a material of the retardation layer 54 due to light incident on the polarization conversion element 5, and heat generated in association with the incidence of the light, the free radicals can be desorbed from the surface of the retardation layer 54 to the outside with the exposure region 54B interposed therebetween. Therefore, it is possible to suppress the progress of a deterioration in the retardation layer 54 due to the free radicals, and to suppress a deterioration in the polarization conversion element 5.

In addition, since the reflection suppression layer 56 that suppresses reflection is provided on the light emitting surface 51B of the main body 50, it is possible to prevent light reaching the interface of the main body 50 from returning to the inner side due to internal reflection. Therefore, it is possible to easily emit the light reaching the interface to the outside. Therefore, since the amount of light to be emitted can be made smaller than the amount of incident light, it is possible to improve the use efficiency of light.

In the reflection suppression layer 56, an action is used in which reflected light is suppressed due to interference between light reflected from the light incident side of the reflection suppression layer 56 and light reflected from the light emitting side, and changes in the refractive indexes of mediums on the light incident side and the light emitting side in the reflection suppression layer 56 cause an effect of suppressing reflection not to be sufficiently obtained. For this reason, in a case where the reflection suppression layer 56 is formed on the light incident side of the retardation layer 54, in other words, a case where the retardation layer 54 is located on the light emitting side of the reflection suppression layer 56, the function of the reflection suppression layer 56 decreases. That is, light has a tendency to be reflected at the interface between the light emitting end surface (light emitting surface 51B) of the light-transmitting member 51 and the reflection suppression layer 56, and thus the transmittance of light decreases.

On the other hand, since the reflection suppression layer 56 is not formed between the light-transmitting member 51 and the retardation layer 54, light incident on the retardation layer 54 from the main body 50 can be suitably caused to be incident on the retardation layer 54, and thus it is possible to suitably exhibit the effect of an improvement in the use efficiency of the light.

According to the projector 1 of the present embodiment, it is possible to exhibit the same operational effect as that of the polarization conversion element 5. In addition, since the use efficiency of light is improved by the polarization conversion element 5, it is possible to cause higher-luminance light to be incident on the liquid crystal panel 453 as a light modulation device, and to thereby increase in the luminance of an image which is formed and projected.

### Second Embodiment

Next, a second embodiment of the invention will be described.

A projector according to the present embodiment includes the same configuration as that of the projector 1. Here, in the polarization conversion element 5, the retardation layer is configured not to be provided with the reflection suppression layer 56. On the other hand, in the projector according to the present embodiment, at least a portion of the retardation layer 54 is covered with the reflection suppression layer 56. In this point, the projector according to the present embodiment and the projector 1 are different from each other. In the following description, the same or substantially same components as the components having previously described are denoted by the same reference numerals and signs, and thus the description thereof will not be given.

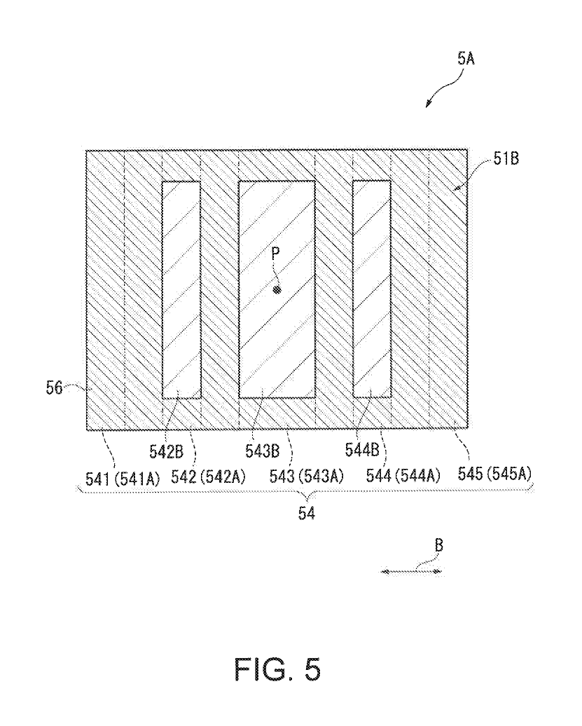

FIG. 5 is a schematic diagram when a polarization conversion element 5A included in the projector according to the present embodiment is seen from the light emitting side.

The projector according to the present embodiment has the same configuration and function as those of the projector 1, except that the polarization conversion element 5A is included instead of the polarization conversion element 5.

The polarization conversion element 5A is an element that functions similarly to the polarization conversion element 5, and includes the main body 50 provided with the polarized light separation layer 52, the reflection layer 53 and the retardation layer 54, the light shielding plate 55 (which is not shown in FIG. 5), and the reflection suppression layer 56, as shown in FIG. 5.

Among these components, the retardation layer 54 is constituted by a first retardation layer 541, a second retardation layer 542, a third retardation layer 543, a fourth retardation layer 544, and a fifth retardation layer 545 which are disposed at positions corresponding to the polarized light separation layer 52 on the light emitting surface 51B.

Among these retardation layers 541 to 545, the first retardation layer 541 and the fifth retardation layer 545 which are located on both ends of the main body 50 in a horizontal direction (direction B), that is, the entire regions of light emitting-side surfaces 541A and 545A of the respective retardation layers 541 and 545 which are away from a center P of the light emitting surface 51B are covered with the reflection suppression layer 56. On the other hand, some of the second retardation layer 542, the third retardation layer 543, and the fourth retardation layer 544 which are located in the center of the main body 50 in a horizontal direction, that is, some of light emitting-side surfaces 542A, 543A, and 544A of the retardation layers 542 to 544 which are close to the center P are covered with the reflection suppression layer 56. Specifically, in the retardation layers 542 to 544 of which some are covered with the reflection suppression layer 56, the reflection suppression layer 56 is formed at a position away from the center P, on these light emitting-side surfaces 542A, 543A, and 544A.

As described above, a flux of light incident from the light source device 41 is configured such that the density of light in the vicinity of the central axis (illumination optical axis AX) of the flux of light is higher than the density of light on the outer edge side. From this, the density of light incident on the polarization conversion element 5A through the respective lens arrays 421 and 423 is high in the central area of the polarization conversion element 5A, and decreases with distance from the central area.

In this manner, the density of a flux of light emitted from the light source device 41 becomes higher in the periphery (central area) of the center P of the polarization conversion element 5A. Therefore, in the present embodiment, exposure regions 542B, 543B, and 544B are located in the central area on the light emitting-side surface 54A of the retardation layer 54. In other words, the reflection suppression layer 56 is provided in portions which are not provided with the exposure regions 542B, 543B, and 544B on the light emitting-side surfaces 542A to 544A of the second to fourth retardation layers 542 to 544 which are located in the central area in the retardation layer 54, and in the entire regions of the light emitting-side surfaces 541A and 545A of the first and fifth retardation layers 541 and 545.

Thereby, since the exposure regions 542B, 543B, and 544B are located in areas in which a large amount of free radicals have a tendency to be generated from the material of the retardation layer 54 due to light incident on the polarization conversion element 5A, and heat generated in association with the incidence of the light, it is possible to easily desorb these free radicals to the outside, and to suppress the stagnation of the free radicals.

### Effects of Second Embodiment

The projector according to the present embodiment described above can exhibit the same effects as those of the projector 1, and can additionally exhibit the following effects.

As described above, it is considered that more free radicals generated due to the light and heat emitted from the light source device 41 are generated in a portion having a high density of light than in a portion having a low density of the light. For this reason, in a case where the retardation layer 54 located in an area having a high density of light to be incident is sealed with other layers such as the reflection suppression layer 56, deterioration caused by the free radicals is further promoted.

On the other hand, in the present embodiment, the exposure regions 542B, 543B, and 544B are provided in areas having a higher density of light to be incident from the inner side than in other areas, on the light emitting surface 51B. In other words, since the light emitting-side surfaces 542A, 543A, and 544A of the second to fourth retardation layers 542, 543, and 544 which are areas where more free radicals have a tendency to be generated than in other areas are not sealed with other layers such as the reflection suppression layer 56, the free radicals can be easily desorbed from the light emitting-side surfaces 542A, 543A, and 544A. Therefore, it is possible to prevent a deterioration in the retardation layer 54 and a deterioration in the polarization conversion element 5A from being promoted.

In addition, on the light emitting surface 51B, the light emitting-side surfaces 541A and 545A of the first and fifth retardation layers 541 and 545 having a relatively low density of light to be incident are not provided with the exposure region, and thus the reflection suppression layer 56 can be formed in the area. Therefore, it is possible to suitably exhibit the effect of an improvement in the use efficiency of the light.

As described above, a flux of light incident from the light source device 41 is configured such that the density of light in the vicinity of the central axis of the flux of light is higher than the density of light on the outer edge side. From this, the density of light incident on the polarization conversion element 5A through the respective lens arrays 421 and 423 is high in the central area of the polarization conversion element 5A, and decreases with distance from the central area.

On the other hand, according to the present embodiment, on the light emitting surface 51B, the light emitting-side surfaces 542A, 543A, and 544A of the second to fourth retardation layers 542, 543, and 544 located in a substantially central portion having a higher density of light than in other areas are provided with the exposure regions 542B, 543B, and 544B. Thereby, a large amount of free radicals generated from the second to fourth retardation layers 542, 543, and 544 due to light to be incident and heat to be generated can be easily desorbed to the outside. Therefore, it is possible to reliably prevent a deterioration in the retardation layer 54 and a deterioration in the polarization conversion element 5A from being promoted.

As described above, the light emitting-side surfaces 541A and 545A of the first and fifth retardation layers 541 and 545 having a relatively low density of light to be incident are not provided with the exposure region, and thus the reflection suppression layer 56 can be formed in the area. Even in a case where such a reflection suppression layer 56 is formed in the first and fifth retardation layers 541 and 545, the amount of the free radicals generated due to light to be incident and heat to be generated is smaller than those of the second to fourth retardation layers 542, 543, and 544 having a high density of light to be incident, and deterioration is not likely to progress. Therefore, the reflection suppression layer 56 is formed in such an area, and thus it is possible to suitably exhibit the effect of an improvement in the use efficiency of the light.

### Modification of Embodiment

The invention is not limited to the respective embodiments, and modifications, improvements and the like within a range capable of achieving the object of the invention are included in the invention.

In the first embodiment, the reflection suppression layer 56 is not provided in the retardation layer 54. In the second embodiment, the reflection suppression layer 56 is provided on the basis of the density of light to be incident. However, the invention is not limited thereto.

For example, the reflection suppression layer 56 may be provided so that a portion having the reflection suppression layer 56 provided therein and the exposure region 54B are alternately provided in a vertical direction or horizontal direction (so-called, border shape or stripe shape).

In addition, for example, the entire regions of the light emitting-side surfaces 542A to 544A of the second to fourth retardation layers 542, 543, and 544 included in the central area may be configured as the exposure region 54B. Further, the light emitting-side surfaces 542A to 544A of the second to fourth retardation layers 542, 543, and 544 may be provided with the circular exposure region 54B centering on the center P.

Further, for example, only the light emitting-side surface 543A of the third retardation layer 543 may be provided with the exposure region 543B, and on the light emitting-side surfaces 542A and 544A of the second and fourth retardation layers 542 and 544, similarly to the light emitting-side surfaces 541A and 545A of the first and fifth retardation layers 541 and 545, the entire regions of the light emitting-side surfaces 542A and 544A may be provided with the reflection suppression layer 56.

Additionally, in a case where the reflection suppression layer 56 is formed in the retardation layer 54, the reflection suppression layer 56 may be configured to be provided with an opening serving as the exposure region 54B.

That is, insofar as a portion of the retardation layer 54 is provided with the exposure region 54B, a position at which the reflection suppression layer 56 is formed can be appropriately changed.

In the second embodiment, a portion in the retardation layer 54 having a high density of a flux of light incident from the light source device 41 on the light emitting-side surface 54A is set to the central area of the polarization conversion element 5A. However, the invention is not limited thereto. For example, in a case where the density of light of portions other than the central area becomes higher when a plurality of light sources of the light source device 41 are present or the positions of the light sources are not located in the center of the light source device 41, a portion having a high density of the light may be provided with the exposure region. That is, insofar as the reflection suppression layer 56 is provided in a portion having a low density of light, the layer may be provided in any area on the light emitting surface 51B of the polarization conversion element 5A.

In the respective embodiments, the reflection suppression layer 56 is constituted by an AR coating which is formed by evaporating substances such as silicon dioxide and titanium oxide. However, the invention is not limited thereto. For example, the reflection suppression layer 56 may be formed by sputtering substances such as silicon dioxide and titanium oxide, or applying a fluorine substance such as magnesium fluoride.

Further, the reflection suppression layer 56 may have an air-permeable AR coating evaporated thereon. According to this, even in a case where the free radicals are generated in the retardation layer 54 due to light and heat from the light source device 41, the free radicals can be desorbed through the AR coating, and thus it is possible to suppress deteriorations in the retardation layer 54 and the polarization conversion elements 5 and 5A.

In addition, in the respective embodiments, a protective layer or the like that protects the polarization conversion elements 5 and 5A may be provided instead of the reflection suppression layer 56, or together with the reflection suppression layer 56. In this case, the exposure region 54B is also provided, and thus it is possible to suppress deteriorations in the retardation layer 54 and the polarization conversion elements 5 and 5A. That is, a layer which is formed on the light emitting-side surface 54A of the retardation layer 54 is not limited to the reflection suppression layer 56, and layers having other functions may be provided with the exposure region.

In the respective embodiments, the retardation layer 54 is disposed at a position corresponding to the polarized light separation layer 52 on the light emitting-side end surface of the main body 50. However, the invention is not limited thereto. For example, a configuration may be used in which the retardation layer 54 is attached to a portion of the light flux emitting end surface of the main body 50 where linearly polarized light reflected from the reflection layer 53 is emitted, and the polarization direction of the linearly polarized light reflected from the reflection layer 53 is rotated by 90°.

In the respective embodiments, the image forming device 4 is formed in a substantially L-shape along each of the back side and the right side, but the invention is not limited thereto. For example, an optical unit formed in a substantially U-shape may be adopted.

In the respective embodiments, the transmission-type liquid crystal panel 453 of which the light flux incident surface and the light flux emission surface are different from each other has been used, but a reflection-type liquid crystal panel of which the light incident surface and the light emitting surface are the same as each other may be used.

In the respective embodiments, the projector 1 is configured to include three liquid crystal panels 453R, 453G, and 453B, but the invention is not limited thereto. That is, the invention can also be applied to a projector using two or less, or four or more liquid crystal panels 453.

In the respective embodiments, the transmission-type liquid crystal panel 453 is used in which the light incident surface and the light emitting surface are different from each other, but a reflection-type liquid crystal panel of which the light incident surface and the light emitting surface are the same as each other may be used. In addition, insofar as a light modulation device is used which is capable of forming an image based on image information by modulating a flux of incident light, a device using a micromirror, for example, a light modulation device other than a liquid crystal such as a device using a digital micromirror device (DMD) may be used.

In the respective embodiments, the light source device 41 is configured to include the light source lamp 411 and the reflector 412 that reflects light emitted from the light source lamp 411. However, the invention is not limited thereto. For example, the number of light source lamps may be two, and may be three or more. In addition, the light source device 41 is not limited to a configuration in which the light source lamp 411 is included, and may be configured to include a solid-state light source such as a light emitting diode (LED) or a laser diode (LD).

In the respective embodiments, the front-type projector 1 is illustrated in which the projection direction of an image and the observation direction of the image are substantially the same as each other. However, the invention is not limited thereto. For example, the invention can also be applied to a rear-type projector in which the projection direction and the observation direction are opposite to each other.

### REFERENCE SIGNS LIST

1: projector, 41: light source device, 453, 453R, 453G, 453B: liquid crystal panel (light modulation device), 46: projection optical device, 5, 5A: polarization conversion element, 50: main body, 51: light-transmitting member, 51A: light incident surface, 51B: light emitting surface, 52: polarization separation layer, 53: reflection layer, 54: retardation layer, 541: first retardation layer, 542: second retardation layer, 543: third retardation layer, 544: fourth retardation layer, 545: fifth retardation layer, 54A, 541A, 542A, 543A, 544A, 545A: light emitting-side surface, 54B, 542B, 543B, 544B: exposure region, 56: reflection suppression layer

1-5. (canceled)

6. A polarization conversion element comprising:
a main body provided with a light-transmitting member,
a polarized light separation layer that transmits first polarized light having one polarization direction out of light to be incident, and reflects second polarized light having the other polarization direction,
a reflection layer, disposed between the polarized light separation layer and the light-transmitting member, which reflects the second polarized light reflected by the polarized light separation layer, and causes the second polarized light to travel along a traveling direction of the first polarized light having passed through the polarized light separation layer, and
a retardation layer, disposed on a light emitting end surface of the light-transmitting member on any light emitting side of the polarized light separation layer and the reflection layer, which converts one polarized light of the first polarized light and the second polarized light into the other polarized light and emits the other polarized light; and
a reflection suppression layer that suppresses reflection from a light emitting surface in the main body,
wherein the main body includes an exposure region for exposing at least a portion of a region of a light emitting-side surface in the retardation layer.

7. The polarization conversion element according to claim 6, wherein the exposure region is provided in an area having a higher density of light to be emitted than in other areas, on the light emitting-side surface.

8. The polarization conversion element according to claim 7, wherein the area having a higher density of the light than other areas is located in a substantially central portion of the light emitting-side surface, and
the exposure region is provided at the substantially central portion of the light emitting-side surface.

9. The polarization conversion element according to claim 6, wherein the reflection suppression layer is not formed between the light-transmitting member and the retardation layer.

10. The polarization conversion element according to claim 7, wherein the reflection suppression layer is not formed between the light-transmitting member and the retardation layer.

11. The polarization conversion element according to claim 8, wherein the reflection suppression layer is not formed between the light-transmitting member and the retardation layer.

12. A projector comprising:
a light source device;
a light modulation device that modulates light emitted from the light source device;
a projection optical device that projects the light modulated by the light modulation device; and
the polarization conversion element according to claim 6 which is disposed between the light source device and the light modulation device.

13. A projector comprising:
a light source device;
a light modulation device that modulates light emitted from the light source device;
a projection optical device that projects the light modulated by the light modulation device; and
the polarization conversion element according to claim 7 which is disposed between the light source device and the light modulation device.

14. A projector comprising:
a light source device;
a light modulation device that modulates light emitted from the light source device;
a projection optical device that projects the light modulated by the light modulation device; and
the polarization conversion element according to claim 8 which is disposed between the light source device and the light modulation device.

15. A projector comprising:
a light source device;
a light modulation device that modulates light emitted from the light source device;
a projection optical device that projects the light modulated by the light modulation device; and
the polarization conversion element according to claim 9 which is disposed between the light source device and the light modulation device.

16. A projector comprising:
a light source device;
a light modulation device that modulates light emitted from the light source device;
a projection optical device that projects the light modulated by the light modulation device; and
the polarization conversion element according to claim 10 which is disposed between the light source device and the light modulation device.

17. A projector comprising:
a light source device;
a light modulation device that modulates light emitted from the light source device;
a projection optical device that projects the light modulated by the light modulation device; and
the polarization conversion element according to claim 11 which is disposed between the light source device and the light modulation device.
